(19) United States
(12) Patent Application Publication
(10) Pub. No.: US 2021/0224847 A1
(43) Pub. Date: Jul. 22, 2021

(54) Geo-Targeted Weather-Based Marketing in Social Networks

(71) Applicants: Planalytics, Inc., Berwyn, PA (US); Brand Networks, LLC, Boston, MA (US)

(72) Inventors: Frederic D. FOX, Berwyn, PA (US); Michael GARSIN, Boston, MA (US)

(73) Assignees: Planalytics, Inc., Berwyn, PA (US); Brand Networks, LLC, Boston, MA (US)

(21) Appl. No.: 14/613,972

(22) Filed: Feb. 4, 2015

Related U.S. Application Data
(60) Provisional application No. 61/956,187, filed on Feb. 7, 2014.

(51) Int. Cl. G06Q 30/02; G06Q 50/00

(52) U.S. Cl. CPC G06Q 30/0252; G06Q 50/01; G06Q 30/0261

(57) ABSTRACT

Disclosed herein are system, method, and computer program products for providing geographically targeted weather-based marketing in a social network. For example, the method operates by receiving weather-driven marketing recommendation data based on an analysis of historical weather data, historical sales data and a weather forecast, and transforming the weather-driven marketing recommendation data into electronic marketing content. The marketing content can then be transmitted to a social network for targeted publishing.

### CROSS-REFERENCE TO RELATED APPLICATIONS

This application claims the benefit of U.S. Provisional Appl. No. 61/956,187, filed Feb. 7, 2014, which is hereby incorporated by reference in its entirety.

### TECHNICAL FIELD

Embodiments are generally related to using weather analytics for geographically targeted marketing and advertising.

### BACKGROUND

Effective electronic or computerized marketing and advertising of products involves understanding the unique demographic and geographic characteristics involving consumers' and their evolving needs, desires and problems. Even during times when consumers exercise prudence, an immediate change, problem or desire may trigger a buying decision. For example, a future weather event can trigger a sudden spike in demand for some products. Sellers can take advantage of these spikes by electronically monitoring demand-triggering conditions and reacting quickly to those conditions. But in order to do so, sellers may have to identify geographical regions where the demand will emerge, and be able to reach potential consumers in those regions with event-tailored marketing.

### SUMMARY

With the advent of the internet, online retailers are faced with the problem of effectively marketing and advertising their inventory to customers both locally and around the world. Prior to the internet, retailers often only had to focus on selling their products and services to local customers in a single geographic area. However, the internet has created a difficult challenge to online retailers whose customers now include individuals or businesses in different geographic regions. Online retailers are faced with the challenge of not only tailoring their inventory to account for the different geographic regions, but also predicting conditions (e.g., weather conditions) specific to those geographic regions. In addition, such tailoring of inventory has to occur immediately in order to provide proper marketing and advertisements to customers in real-time. Therefore, it would be desirable for online retailers to have a mechanism that electronically provides geographically targeted weather-driven marketing through web-based social networks.

Embodiments can operate by receiving an electronic weather-driven marketing recommendation based on an analysis of historical weather data, historical sales data and a weather forecast, and generating electronic marketing content based on the marketing recommendation. The electronic marketing content can then be transmitted to a social network for targeted publishing. Additionally, input for the electronic weather-driven marketing recommendation can be received as feedback from previous marketing content sent to the social network.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a networked environment that includes geo-targeted weather-based market analysis and market content integration engines, according to an example embodiment.

FIG. 2 is a block diagram of a marketing content integration engine, according to an example embodiment.

FIG. 3 is a flowchart depicting a process for a seller to subscribe to a weather-based social network marketing system, according to an example embodiment.

FIG. 4 is a flowchart depicting a process for posting weather-based marketing messages and ads to a social network, according to an example embodiment.

FIG. 5 is a flowchart depicting a process for detecting and alerting of an upcoming weather-based market opportunity event, according to an example embodiment.

FIG. 6 is an example computer system useful for implementing various embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals, and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

Provided herein are system, method and/or computer program product embodiments, and/or combinations and sub-combinations thereof, for providing geographically targeted weather-based marketing in a social network.

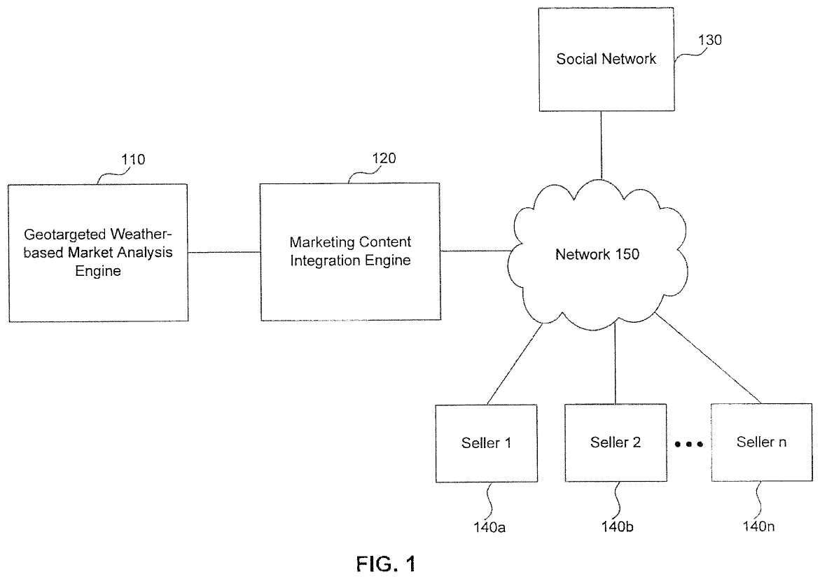

FIG. 1 is a block diagram of a networked environment 100, according to an example embodiment. For example, environment 100 includes geo-targeted weather-based market analysis and market content integration engines for providing geo-targeted weather-based marketing in a social network.

Networked environment 100 can include a geo-targeted weather-based market analysis engine 110, a marketing content integration engine 120, a social network 130 and online sellers 140a-140n.

Market analysis engine 110 can determine a marketing outlook for products, or categories of products, based on multiple factors. In an embodiment, market analysis engine 110 transforms electronic data, such as historical weather data, historical sales data, historical customer information, and/or weather forecast data into a demand projection for a product category at a particular geographic location. For example, market analysis engine 110 can determine that the next two days at a particular location will be rainy. Market analysis 110 can analyze prior sales data for similar rainy conditions at this particular location, and conclude that during the next two days there will be a high demand for rain boots in this particular geographic area. In this manner, market analysis engine 110 can detect hyper-located real-time market trends.

Market analysis engine 110 can compute weather-based market forecasts by, for example, using methods and analytics described in U.S. Pat. No. 5,832,456, which is incorporated herein by reference in its entirety. In an embodiment, market analysis engine 110 obtains electronic weather data for targeted geographic regions, for example, state, county, area code, postal code, etc. Market analysis engine 110 can also obtain electronic sales data from point-of-sales in the targeted regions. The electronic weather and sales data can include date and time information, in order to account for the different impacts of similar weather conditions during various times of the year (e.g., a 60° F. in February may have a different impact than in July). Market analysis engine 110 can generate electronic favorability models of consumer demand based on the above-mentioned data.

Marketing content integration engine 120 can receive electronic weather-driven market forecast information from market analysis engine 110 and can transform the weather-driven market forecast information into electronic marketing content. In an embodiment, integration engine 120 can transform the weather-driven market forecast information into composite electronic marketing content by analyzing the weather-driven market forecast information and utilizing the analysis to generate electronic marketing content or select electronic marketing content from a database. For example, if the electronic weather-driven market forecasting information is weather and sales data indicative of rain, resulting in a high demand for rain boots in the next two days, integration engine 120 can analyze the electronic market forecasting information and generate electronic marketing content for advertising rain boots. In an embodiment, marketing content integration engine 120 can transmit, via network 150, the generated electronic marketing content to a social network 130 for targeted publishing.

In an embodiment, market analysis engine 110 and marketing content integration engine 120 can be provided as network services accessible through, for example, the Internet. For example, analysis engine 110 and integration engine 120 can comprise a cloud computing service, that online sellers 140 and social network 130 can interact with.

Social network 130 can be a web-based computing platform for people and entities to share information and media with other users. Social network 130 can allow users, such as, for example, individuals, companies, organizations, etc., to selectively share information and media with other users. Social network 130 can be, for example, Facebook™, Twitter™, LinkedIn™, Instagram™, Snapchat™, etc. In an embodiment, users of social network 130 can subscribe to receive other users' information and posts. In one example, feedback from a user's use of previous marketing information received by the social network 130 can be used as input to market analysis engine 110.

Online sellers 140a-140n can be clients of marketing content integration engine 120 and marketing analysis engine 110. Online sellers 140a-140n can be any entity in the business of selling products or services, such as, for example, retail stores, online retailers, manufacturers, distributors, etc. Online sellers 140a-140n can communicate with marketing content integration engine 120 and social network 130 to generate electronic advertising and promotions based on weather, market forecasts, and/or previous feedback from the social network 130. In an embodiment, any of online sellers 140a-140n can instruct integration engine 120 to post advertisements to social network 130 on behalf of the online seller. In an embodiment, marketing content integration engine 120 can post advertisements on a social network page of sellers 140a-140n. In an embodiment, online sellers subscribe to receive the advertisement selection services of marketing content integration engine 120 and can provide marketing content integration engine 120 with electronic advertising content.

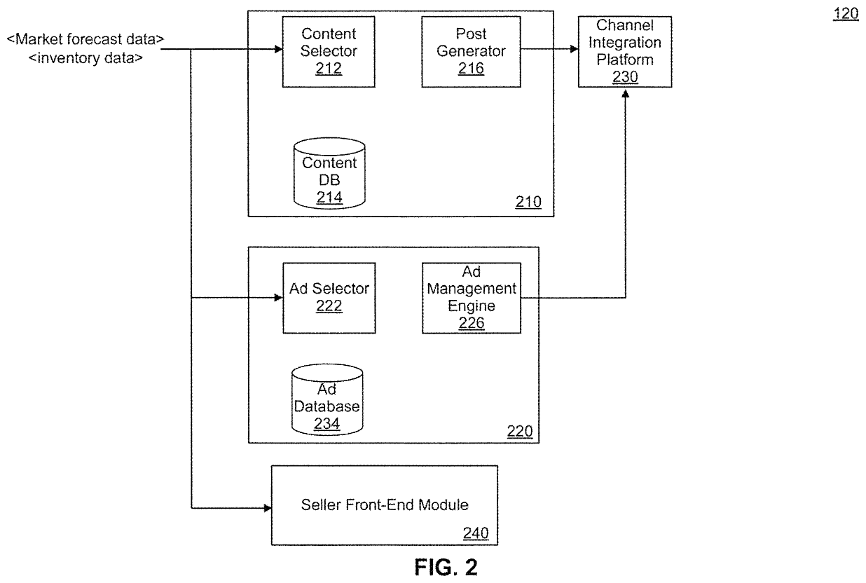

FIG. 2 is a block diagram showing further details of marketing content integration engine 120, according to an example embodiment.

Marketing content integration engine 120 can include social network post module 210, social network ad module 220, channel integration platform 230, and seller front-end module 240.

Social network post module 210 can generate or select and transmit social network posts based on received weather-driven market forecast data. Social network post module 210 can include a content selector 212, a content database 214, and a post generator 216.

Content selector 212 can be configured to generate marketing content for targeted publishing based on the received weather-driven market forecast data. For example, analysis of the electronic market forecast data can reveal what products or categories of products will be in high or low demand during a future time. Content selector 212 can then utilize the analysis of the electronic weather market forecast data to generate composite marketing content by retrieving different types of data from content database 214 to post on social network 130. In an embodiment, the sellers 140a-140n can configure content selector 212 to (i) generate customized electronic marketing content to be posted and (ii) configure when the posts should be published. In an embodiment, content selector 212 receives electronic information such as inventory data from the sellers, and can analyze the inventory data to generate marketing content tailored to the seller's inventory.

In an embodiment, content selector 212 can also receive, via network 150, electronic historical customer information data from social network 130, such as, for example, user profile information, user activity trends, seller subscriber statistics, user demographics information, purchase history, etc., and use this information to improve marketing content generation. In an embodiment, content selector 212 electronically receives social network user demographics information, such as, for example, age, location, sex, etc. Based on the historical customer information, content selector 212 can determine what products will have a high demand from individual users of social network 130, or users subscribing to the seller's social network page.

Content database 214 can include electronic data used to generate composite electronic marketing content for targeted publishing in social network 130. The electronic data can be used to generate composite electronic marketing content that will be posted recommending a product, service, or offer on behalf of sellers 140a-140n. Composite electronic marketing data includes a combination of the different types of electronic data stored in content database 214. Electronic data can include, for example, a pre-recorded or pre-scribed message promoting a product or service, a weather forecast, an image of the product or description of a service, a hyperlink to a website where a customer can buy the product or service, etc. Different electronic data components are utilized to generate composite marketing content that is then posted in social network 130. For example, the electronic data in content database 214 can be used to generate a composite marketing content post including the message “It's raining, it's pouring! With 6 inches of rain coming our way, keep dry with our Women's Multi Dot Rain Boots,” along with a picture of the rain boots and hyperlink to the website where the product is sold. In another example, the electronic data is utilized to generate a composite electronic marketing content post including the message “Snow is coming, we can plow,” along with contact information and/or a hyperlink to the website where the product is sold. In an embodiment, content database 214 includes standard templates that are utilized to generate and distribute composite electronic marketing content posts on behalf of subscribed sellers based on weather triggers. In an embodiment, sellers 140a-140n provide electronic data to be included in content database 214.

Post generator 216 can receive content generated or selected by content selector 212 and generate a post for targeted publishing in social network 130.

Social network ad module 220 can select, adjust and transmit electronic ads for targeted publishing in a social network based on received electronic market forecast data. Social network ad module 220 includes an ad selector 222, an ad database 224, and an ad management engine 226.

Ad selector 222 can be configured to generate and adjust ads for targeted publishing based on the received market forecast data. Content selector 222 can generate an ad utilizing data stored in ad database 224 to publish based on the market forecast. In an embodiment, the sellers 140a-140n can configure ad selector 222 to customize ads to be posted and configure when the ads should be published. In an embodiment, ad selector 222 electronically receives inventory data or availability for services from the sellers, and can select ads based on a seller's inventory or availability.

Ad database 214 can contain electronic data used to generate or select ads for targeted publishing in social network 130. The electronic data used to generate ads can include, for example, an image, a video, a hyperlink to a website where a customer can buy the product or service, etc. In an embodiment, ad database 224 contains electronic data used to generate, adjust or select ads provided by sellers 140a-140n.

Ad management engine 226 can receive ads generated or selected by ad selector 222 and publish them in social network 130.

Channel integration platform 230 can receive electronic marketing posts and electronic ads from social network post module 210 and social network ad module 220 and prepare and transmit them for targeted publishing to social network 130. In an embodiment, channel integration platform can receive feedback from social network 130, such as, for example, user comments, approval rating (e.g., Facebook “Likes”), social network “Follow” or “Subscribe” trends, and incorporate this feedback into the marketing content selection.

Seller front-end module 240 can provide an interface for sellers to electronically subscribe to and electronically configure the targeted publishing of social network posts and ads based on weather triggers. In an embodiment, seller front-end module 240 provides a graphical user interface through the Internet, such as, for example, a website, a mobile application, a tablet application, etc. Sellers can configure their weather-based publishing by, for example, providing electronic information on products or products categories that the seller sells, providing electronic data, marketing content and ads for publishing, setting rules for publishing based on weather triggers, selecting or generating marketing content for publishing based on weather-based recommendations, etc. Rules can specify, for example, that certain products should be automatically promoted, or certain posts should be automatically published, when a weather-based marketing trigger is detected.

In an embodiment, seller front-end module 240 electronically receives market forecast data and electronically transmits notifications of upcoming market events to sellers. The notification can be, for example, an email, a text message, a push notification sent to a seller's mobile device, etc. An electronic notification can, for example, alert a seller that a particular product, service, or category will be on high demand soon. In an embodiment, a seller receiving a market forecast alert can be provided with options to respond and instruct the seller front-end module 240 to perform an action. For example, seller front-end module can provide a seller with a list of electronic marketing posts for publishing on social network 130, and allow the user to select one or more for posting. In an embodiment, a seller can provide data utilized to generate or adjust electronic marketing content for posting on social network 130, such as, for example, a text, an image, a video, etc. In an embodiment, the seller can also select a social network 130 out of multiple social networks for posting the marketing content.

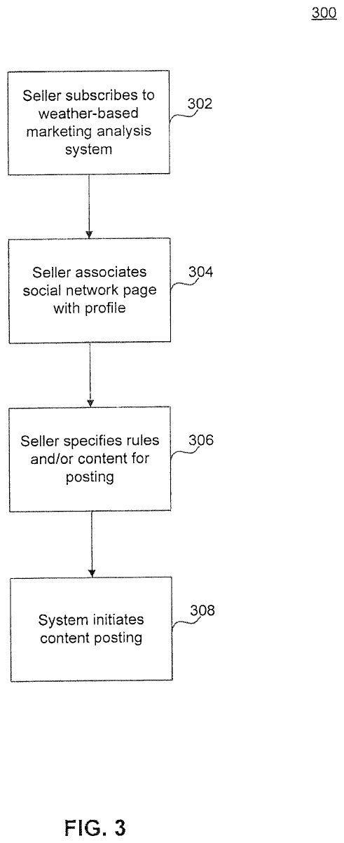

FIG. 3 is a flowchart depicting a process (e.g., a process can be a method or operation) for a seller to electronically subscribe to a weather-based social network marketing system, according to an example embodiment. Not every step need be performed, nor be performed in the depicted sequence, as those skilled in the relevant arts will recognize. In an embodiment, online seller 140a-140n communicates with front-end module 240 of integration engine 120 to perform steps 302-306 of subscribing and initializing the marketing service.

At step 302, an online seller 140a-140n can subscribe to the weather-based social network marketing system. In an embodiment, an online seller 140a-140n creates a profile and provides identifying information to integration engine 120. In an embodiment, an online seller 140a-140n provides information regarding the products, services, and categories of products that it sells, and can provide access to an inventory database or availability. In an embodiment, an online seller 140a-140n can provide one or more geographic locations where the seller offers products or services for sale, also known as points-of-sale. In an embodiment, an online seller 140a-140n will receive marketing forecast, alert, and social network posting services for the points-of-sale to which the seller subscribes. For example, if an online seller 140a-140n is an online retailer, the seller can indicate one or more points-of-sales where the seller ships its goods or provides its services, and can configure a profile in integration engine 120 to provide marketing forecast and services for the specified locations.

At step 304, an online seller 140a-140n can link the seller's marketing system profile with an online seller's social network profile. In an embodiment, seller 140a-140n provides integration engine 120 information about a social network page associated with the seller, and information to allow integration engine 120 to access and post information to the page. In an embodiment, online seller 140a-140n provides integration engine 120 electronic information about social network pages associated with points-of-sale where the seller sells its products or services. For example, if a seller has retail stores in multiple points-of-sale, the seller can create and associate various social network pages for the various point-of-sales, and configure them for independent posting of weather-based marketing.

At step 306, an online seller 140a-140n can specify rules and content for posting marketing messages and advertisements on social network 130. For example, an online seller 140a-140n can provide messages to be posted on social network 130 when integration engine 120 determines a market event. In an embodiment, an online seller 140a-140n can select messages provided by integration engine 120 for posting. Seller 140a-140n can select messages for posting through front-end module 240. A seller 140a-140n can schedule messages to be posted at a future time, or in response to market forecasts or event triggers.

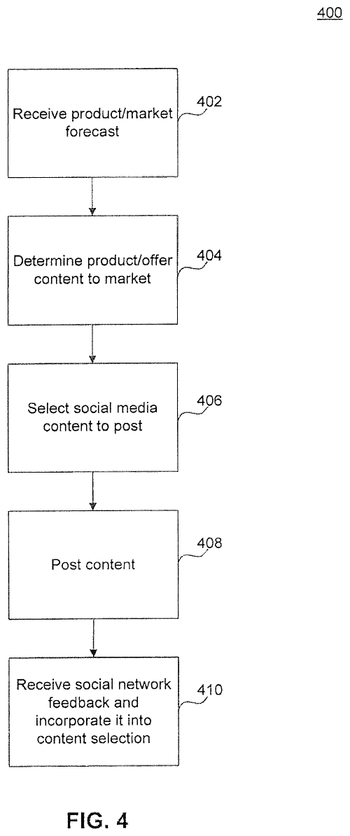

At step 308, integration engine 120 can initiate the posting of messages to social network 130 on behalf of subscribed sellers, as further described with reference to FIG. 4.

FIG. 4 is a flowchart illustrating a process for electronically posting weather-based marketing messages and ads to a social network, according to an example embodiment. Not every step need be performed, nor be performed in the depicted sequence, as those skilled in the relevant arts will recognize.

At step 402, integration engine 120 electronically receives weather-driven market forecast data from market analysis engine 110, as explained above.

At step 404, integration engine 120 analyzes the weather-driven market forecast data in order to determine a product, service, or product category to promote based on the analysis.

At step 406, integration engine 120 can generate or select social media content to post on behalf of online sellers that sell the product, service, or product category involved in the market forecast. In an embodiment, integration engine 120 evaluates rules provided by online seller 140a-140n to determine if an electronic marketing post or electronic advertisement should be posted, and which electronic marketing post or electronic advertisement should be posted.

At step 408, integration engine 120 electronically transmits the electronic marketing post or advertisement for publishing.

At step 410, integration engine 120 electronically receives feedback information from social network 130 regarding social network user response to the electronic marketing post or advertisement. Integration engine 120 can use the feedback information to improve content selection for weather events. For example, integration engine 120 can rank posts or advertisements based on favorable responses from users of social network 130, and select posts or advertisements in the future based on the rankings.

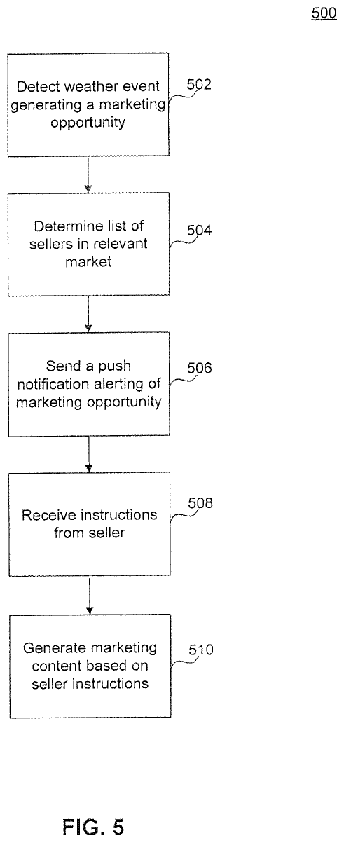

FIG. 5 is a flowchart illustrating a process for detecting and alerting of an upcoming weather-based market opportunity event, according to an example embodiment. Not every step need be performed, nor be performed in the depicted sequence, as those skilled in the relevant arts will recognize.

At step 502, integration engine 120 receives an electronic alert of a weather event generating a marketing opportunity. For example, an electronic alert can indicate that a severe storm is forecasted tomorrow for a geographic area, and that as a result a product, service, or categories of products will see increased demand within that geographic area.

At step 504, integration engine 120 can determine online sellers who sell products and services relevant to the marketing opportunity to customers in the geographic area, i.e., the online sellers in the point-of-sale area for the marketing opportunity.

At step 506, integration engine 120 can transmit an electronic notification to the sellers in the point-of-sale area alerting them of the marketing opportunity. In an embodiment, integration engine 120 transmits a push notification to a mobile device associated with an online seller. As explained above, integration engine 120 can provide the online sellers with options to respond to the marketing opportunity. For example, integration engine 120 can suggest products or services to promote from the seller's inventory available at a point-of-sale and a message for posting in social network 130.

At step 508, integration engine 120 can receive instructions from the online seller regarding posting or advertising in social network 130. In an embodiment, the instructions include a text and an image to post on the social network 130.

At step 510, integration engine 120 can select, generate, or adjust a post or advertisement for posting on social network 130 based on the seller's response.

### Example Computer System

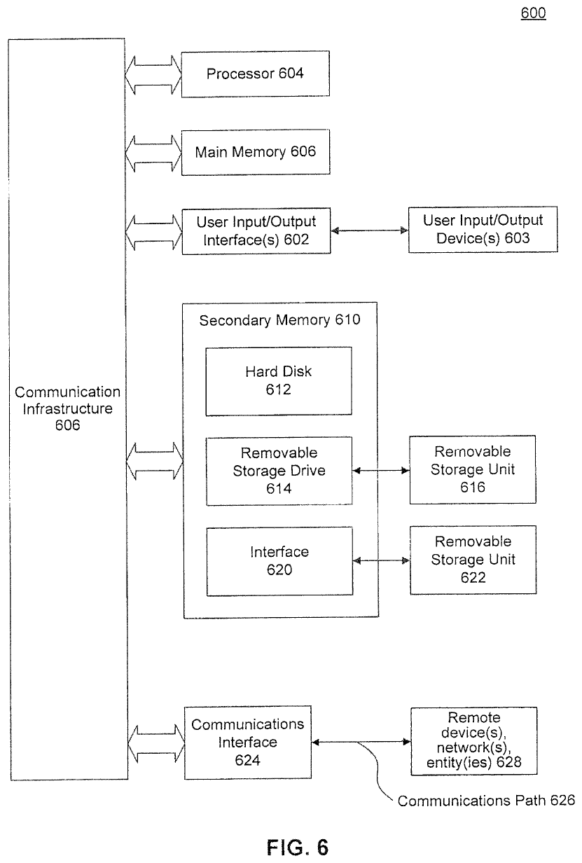

Various embodiments can be implemented, for example, using one or more well-known computer systems, such as computer system 600 shown in FIG. 6. Computer system 600 can be a computer capable of performing the functions described herein, such as computers available from International Business Machines, Apple, Sun, HP, Dell, Sony, Toshiba, etc.

Computer system 600 includes one or more processors (also called central processing units, or CPUs), such as a processor 604. Processor 604 is connected to a communication infrastructure or bus 606. Processor 604 can be a specialized processor such as the marketing content integration engine described above, according to an embodiment.

One or more processors 604 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 600 also includes user input/output device(s) 603, such as monitors, keyboards, pointing devices, etc., which communicate with communication infrastructure 606 through user input/output interface(s) 602.

Computer system 600 also includes a main or primary memory 608, such as random access memory (RAM). Main memory 608 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to an exemplary embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired, and/or wireless, and which may include any combination of LANs, WANs, the Internet, etc. Control logic and/or data may be transmitted to and from computer system 600 via communication path 626.

In an embodiment, a tangible apparatus or article of manufacture comprising a tangible computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 6. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

1-36. (canceled)

37. A computer-implemented content integration method for dynamic real-time individualized marketing publication through a social media platform comprising:
retrieving, by a content integration engine, weather information comprising geographically based weather data, wherein the geographically based weather data includes prior sales data corresponding to weather data at a plurality of locations associated with an online seller, wherein a first location of the plurality of locations is associated with a first point-of-sale for the online seller and a second location of the plurality of locations is associated with a second point-of-sale for the online seller, wherein the first point-of-sale is associated with a first point-of-sale page and the second point-of-sale is associated with a second point-of-sale page;
generating, by the content integration engine, marketing recommendation data associated with the online seller;
adjusting, by the content integration engine, the marketing recommendation data based on at least one rule, feedback from users of the social media platform, and social media information of the online seller to generate a customized marketing recommendation data, wherein the customized marketing recommendation data is associated with the plurality of locations associated with the online seller;
transmitting a push notification to a mobile device associated with the online seller, wherein the push notification includes an interface configured to display a list of electronic marketing posts and an option for providing data for adjusting a selected electronic marketing post from the list of electronic marketing posts;
receiving, via the interface and from the mobile device, a response to the push notification, wherein the response includes the selected electronic marketing post from the list of electronic marketing posts, and the data for adjusting the selected electronic marketing post;
generating, based on the selected electronic marketing post and the data, a second customized marketing recommendation data; and
publishing the second customized marketing recommendation data on the first point-of-sale page.

38. The computer-implemented content integration method of claim 37, wherein the response further includes a second selected electronic marketing post, the method further comprising:
publishing the second selected electronic marketing post on the second point-of-sale page.

39. The computer-implemented content integration method of claim 37, wherein the first location associated with the first point-of-sale is a first geographic location at which the first point-of-sale is located and the second location associated with the second point-of-sale is a second geographic location at which the second point-of-sale is located.

40. The computer-implemented content integration method of claim 37, the method further comprising:
receiving a subscription request from the online seller; and
receiving, responsive to receiving the subscription request, profile information from the online seller, wherein the profile information includes the first location, the second location, and product information of products sold by the online seller.

41. The computer-implemented content integration method of claim 40, the method further comprising:
receiving, responsive to receiving the subscription request, point-of-sale page information from the online seller, wherein the point-of-sale page information identifies the first point-of-sale page and the second point-of-sale page.

42. The computer-implemented content integration method of claim 40, further comprising:
identifying, by the content integration engine, a first product and a second product from the product information, wherein the first product is available for sale at the first point-of-sale and the second product is available at the second point-of-sale.

43. The computer-implemented content integration method of claim 42, wherein the push notification includes the first product and the second product.

44. The computer-implemented content integration method of claim 42, wherein the first product and the second product are identified based on the weather information.

45. The computer-implemented content integration method of claim 37, wherein the first location is a different geographic location from the second location.

46. The computer-implemented content integration method of claim 37, wherein the list of electronic marketing posts includes a first electronic marketing post associated with the first point-of-sale and a second electronic marketing post associated with the second point-of-sale.

47. The computer-implemented content integration method of claim 37, wherein the at least one rule includes a weather trigger specifying that a product is to be automatically included in the customized marketing recommendation data based on the weather information.

48. The computer-implemented content integration method of claim 47, wherein the weather trigger is based on a future weather event identified in the weather information.

49. The computer-implemented content integration method of claim 37, wherein the customized marketing recommendation data includes a first customized marketing recommendation data associated with the first location and a second customized marketing recommendation data associated with the second location.

50. The computer-implemented content integration method of claim 37, wherein the data for adjusting the selected electronic marketing post includes at least one of additional text, an image, or a video.

51. The computer-implemented content integration method of claim 50, wherein in generating the second customized marketing recommendation data, the method further comprises:
incorporating the additional text, the image, or the video into the selected electronic marketing post to generate the second customized marketing recommendation data.

52. The computer-implemented content integration method of claim 37, further comprising:
providing, based on the feedback from the users of the social media platform, a rank of the second customized marketing recommendation data.

53. The computer-implemented content integration method of claim 37, further comprising:
identifying, by the content integration engine, a geographic location associated with the weather information; and
identifying, based on the geographic location and the weather information, the online seller.

54. The computer-implemented content integration method of claim 53, wherein the online seller is identified based on a product sold by the online seller that is associated with the geographic location and the weather information.

55. A content integration engine comprising:
a memory configured to store instructions;
a processor coupled to the memory and configured to:
retrieve weather information comprising geographically based weather data, wherein the geographically based weather data includes prior sales data corresponding to weather data at a plurality of locations associated with an online seller, wherein a first location of the plurality of locations is associated with a first point-of-sale for the online seller and a second location of the plurality of locations is associated with a second point-of-sale for the online seller, wherein the first point-of-sale is associated with a first point-of-sale page and the second point-of-sale is associated with a second point-of-sale page;
generate marketing recommendation data associated with the online seller;
adjust the marketing recommendation data based on at least one rule and social media information of the online seller to generate a customized marketing recommendation data, wherein the customized marketing recommendation data is associated with the plurality of locations associated with the online seller;
transmitting a push notification to a mobile device associated with the online seller, wherein the push notification includes an interface configured to display a list of electronic marketing posts and an option for providing data for adjusting a selected electronic marketing post from the list of electronic marketing posts;
receive, via the interface and from the mobile device, a response to the push notification, wherein the response includes the selected electronic marketing post from the list of electronic marketing posts, the data for adjusting the selected electronic marketing post, and a second selected electronic marketing post;
generate, based on the selected electronic marketing post and the data, a second customized marketing recommendation data; and
publish the second customized marketing recommendation data on the first point-of-sale page.

56. A non-transitory computer-readable medium having instructions stored thereon, execution of which causes a content integration engine to perform operations for dynamic real-time individualized marketing publication through a social media platform comprising:
retrieving, by a content integration engine, weather information comprising geographically based weather data, wherein the geographically based weather data includes prior sales data corresponding to weather data at a plurality of locations associated with an online seller, wherein a first location of the plurality of locations is associated with a first point-of-sale for the online seller and a second location of the plurality of locations is associated with a second point-of-sale for the online seller, wherein the first point-of-sale is associated with a first point-of-sale page and the second point-of-sale is associated with a second point-of-sale page;
generating, by the content integration engine, marketing recommendation data associated with the online seller;
adjusting, by the content integration engine, the marketing recommendation data based on at least one rule, feedback from users of the social media platform, and the social media information of the online seller to generate a customized marketing recommendation data, wherein the customized marketing recommendation data is associated with the plurality of locations associated with the online seller;
transmitting a push notification to a mobile device associated with the online seller, wherein the push notification includes an interface configured to display a list of electronic marketing posts and an option for providing data for adjusting a selected electronic marketing post from the list of electronic marketing posts;
receiving, via the interface and from the mobile device, a response to the push notification, wherein the response includes the selected electronic marketing post from the list of electronic marketing posts, the data for adjusting the selected electronic marketing post, and a second selected electronic marketing post;
generating, based on the selected electronic marketing post and the data, a second customized marketing recommendation data; and
publishing the second customized marketing recommendation data on the first point-of-sale page.
